(19) United States
(12) Patent Application Publication
(10) Pub. No.: US 2006/0256516 A1
(43) Pub. Date: Nov. 16, 2006

(54) Portable computer with detachable display

(76) Inventor: Hyun-je Cho, Seongnam-si (KR)

Correspondence Address: STANZIONE & KIM, LLP, 919 18TH STREET, N.W., SUITE 440, WASHINGTON, DC, 20006, US

(21) Appl. No.: 11/407,235

(22) Filed: Apr. 20, 2006

(30) Foreign Application Priority Data
May 10, 2005 (KR) 2005-38822

(51) Int. Cl. G06F 1/16

(52) U.S. Cl. 361/683

(57) ABSTRACT

A portable computer includes a computer main body, a display, a coupling unit rotatably coupled with the display, and a coupling unit supporter provided in the computer main body and coupled with and released from the coupling unit. In the portable computer with a detachable display, the display is readily detached from and attached to a computer main body, and the display detached from the computer main body has a tilt function.

### CROSS-REFERENCE TO RELATED APPLICATIONS

This application claims the priority of Korean Patent Application No. 2005-0038822, filed May 10, 2005, in the Korean Intellectual Property Office, the entire contents are of which are incorporated herein by reference.

### BACKGROUND OF THE INVENTION

1. Field of the Invention

The present general inventive concept relates to a portable computer, and more particularly, to a portable computer with an improved coupling structure between a computer main body and a display.

2. Description of the Related Art

In general, a portable computer includes a computer main body, a display to display a picture thereon from a video signal received from the computer main body, and a tilting hinge to connect the computer main body with the display so that the display may be tilted to the computer main body.

Among such portable computers, a conventional portable computer with a detachable display has been disclosed in Korean Patent Application No. 1997-040463. This conventional portable computer includes a laptop computer main body, a liquid crystal display (LCD) module to display a picture thereon, an LCD module remover detachably coupled to the LCD module, and a hinge to connect the LCD module remover with the computer main body so that the LCD module remover may be tilted on the computer main body.

The LCD module is provided with a first connection terminal and a coupling pin on one side thereof. Further, the LCD module remover is provided with a second connection terminal coupled to the first connection terminal, and a plurality of grooves to accommodate the coupling pin.

The plurality of grooves are proper for accommodating the coupling pin provided in various LCD modules of different sizes.

Thus, in the conventional portable computer with the detachable display, various LCD modules of different sizes may be selectively mounted to the computer main body.

However, the conventional portable computer does not inform a user that the display may be detached from the computer main body and used as a monitor. In particular, the display detached from the computer main body does not include a hinge, so that it may not have a tilting function.

Further, it is desirable for the conventional portable computer to improve in its structure so that a user may easily detach the display from the computer main body and reattach the display to the computer main body, so that the display is stably coupled to the computer main body without being loosening while the display is attached to the computer main body.

### SUMMARY OF THE INVENTION

Accordingly, it the present general inventive concept provides a portable computer with a detachable display, in which the display is readily detached from and attached to a computer main body, and the display detached from the computer main body has a tilting function.

The present general inventive concept is provides a portable computer with a detachable display, in which the display is detached from a computer main body to be used as a monitor.

Additional aspects and/or advantages of the general inventive concept will be set forth in part in the description which follows and, in part, will be obvious from the description, or may be learned by practice of the general inventive concept.

The foregoing and/or other aspects and utilities of the present general inventive concept may be achieved by providing a portable computer including a computer main body, a display, a coupling unit rotatably coupled with the display, and a coupling unit supporter provided in the computer main body and coupled with and released from the coupling unit.

The coupling unit supporter may be provided in a back region of the computer main body, and the coupling unit is detachably coupled to the coupling unit supporter in a front-to-back direction of the computer main body.

The coupling unit may include a main body, an insertion member protruding from the main body toward the coupling unit supporter, and the coupling unit supporter may include an insertion member accommodator to accommodate the insertion member.

The coupling unit supporter may further include a fastening member coupled with the insertion member to keep the insertion member accommodated in the insertion member accommodator.

The coupling unit supporter may further include an elastic projection to press the insertion member in an opposite direction to an insertion direction of the insertion member.

The insertion member may further include a projection formed in a transverse direction to the insertion direction of the insertion member, and the fastening member may include a holder to hold the projection to prevent the insertion member from breaking away in a backward direction.

The fastening member may further include a spring member to press the holder toward the projection.

The fastening member may include a hinge pin provided in a first side thereof and to allow the fastening member to pivot on a first region of the coupling unit supporter, and a hook provided in a second side thereof and locked to a second region of the coupling unit supporter as the fastening member pivots on the hinge pin, and the coupling unit supporter may include a lever to be locked to and released from the hook.

The coupling unit may further include a locking member protruding from the main body toward the coupling unit supporter, and the coupling unit supporter may further include a locking member accommodator to accommodate the locking member.

The coupling unit supporter may further include a locking projection that is movable in a transverse direction to an insertion direction of the locking member, and the locking member further comprises a locking part coupled with the locking projection when the locking member is accommodated in the locking member accommodator.

The locking projection is movable in an up-and-down direction with respect to the computer main body, and the locking part accommodates the locking projection.

The locking projection contacting the locking part may include an inclined part narrowing toward the end thereof.

The coupling unit supporter may further include a fastening member to be coupled with the insertion member and to keep the insertion member to be accommodated in the insertion member accommodator, and the locking projection may be inserted in the locking part by the fastening member.

The coupling unit supporter may include a guide part formed in a front-to-back direction, and the coupling unit may include a slide part to be guided by the guide part.

The coupling unit may include a connector, and the coupling unit supporter may include a connection port connected with the connector.

The portable computer may further include a port elastic member provided between the connection port and the coupling unit supporter to allow the connection port to be elastically movable and coupled to the coupling unit supporter.

The portable computer may further include a connection cable to connect the connector with the connection port when the display is detached from the computer main body.

The portable computer may further include a display supporting apparatus to support the display when the display is detached from the computer main body.

The display supporting apparatus may further include a stand with a supporter provided in the stand and comprising second the coupling unit supporter to be attached to and detached from the coupling unit.

The second coupling unit supporter may be attached to and detached from the coupling unit in an up-and-down direction of the supporter.

The foregoing and/or other aspects and utilities of the present general inventive concept may be achieved by providing a portable computer including a computer main body having a key unit and a component to generate a video signal, a display to display the video signal, a coupling unit mounted on the display, a coupling unit supporter mounted on the computer main body to be detachably connected to the coupling unit, and a supporting apparatus having a supporter having a second coupling unit supporter mounted thereon to be detachably coupled to the coupling unit.

The foregoing and/or other aspects and utilities of the present general inventive concept may be achieved by providing a portable computer including a computer main body having a key unit, a display, a plurality of coupling units mounted on the display, a plurality of coupling unit supporters mounted on the computer main body and a plurality of connection cables to connect the plurality of the coupling unit to corresponding ones of the coupling unit supporters.

The foregoing and/or other aspects and utilities of the present general inventive concept may be achieved by providing a portable computer including a computer main body having a key unit and a component to generate a video signal, a display to display the video signal, a coupling unit mounted on the display, a coupling unit supporter mounted on the computer main body to be detachably connected to the coupling unit, and a supporting apparatus having a supporter having a second coupling unit supporter mounted thereon to be detachably coupled to the coupling unit.

### BRIEF DESCRIPTION OF THE DRAWINGS

These and other aspects and advantages of the present general inventive concept will become apparent and more readily appreciated from the following description of the embodiments, taken in conjunction with the accompany drawings of which:

FIG. 1 is a perspective view illustrating a portable computer according to an embodiment of the present general inventive concept;

FIG. 2 is a partially exploded perspective view illustrating the portable computer of FIG. 1;

FIGS. 3 through 5 are partial perspective views from the top illustrating a coupling unit to be dissembled and assembled in the portable computer;

FIGS. 6 through 8 are partial perspective views from the bottom illustrating a coupling unit in the portable computer of FIG. 2;

FIG. 9 is a perspective view illustrating a display to be detached from the portable computer of FIG. 2; and

FIGS. 10 and 11 are perspective views illustrating a display detached and attached to a display supporting apparatus from the portable computer according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

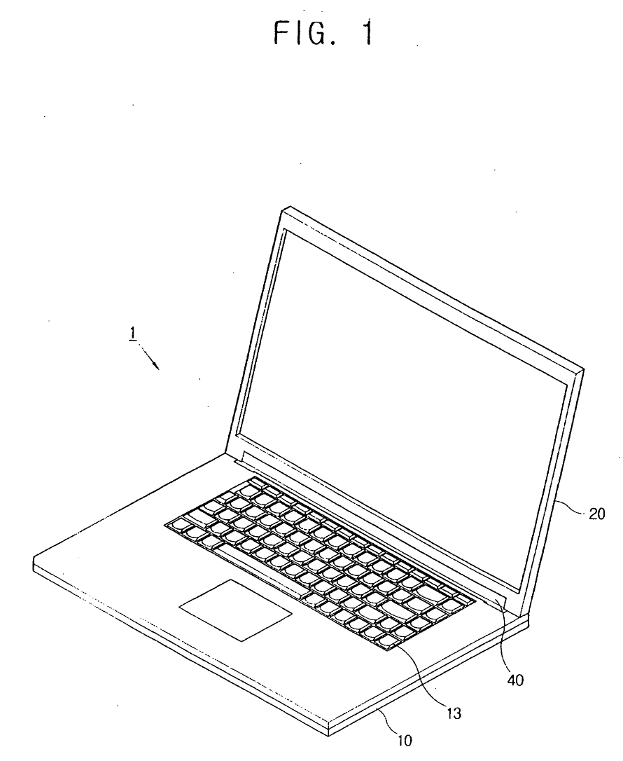

As illustrated in FIG. 1, a portable computer 1 according to an embodiment of the present general inventive concept includes a computer main body 10, a display 20 to display a picture thereon, a coupling unit 40 rotatably coupled to the display 20, and a coupling unit supporter 50 provided in the computer main body 10 and detachably coupled to the coupling unit 40.

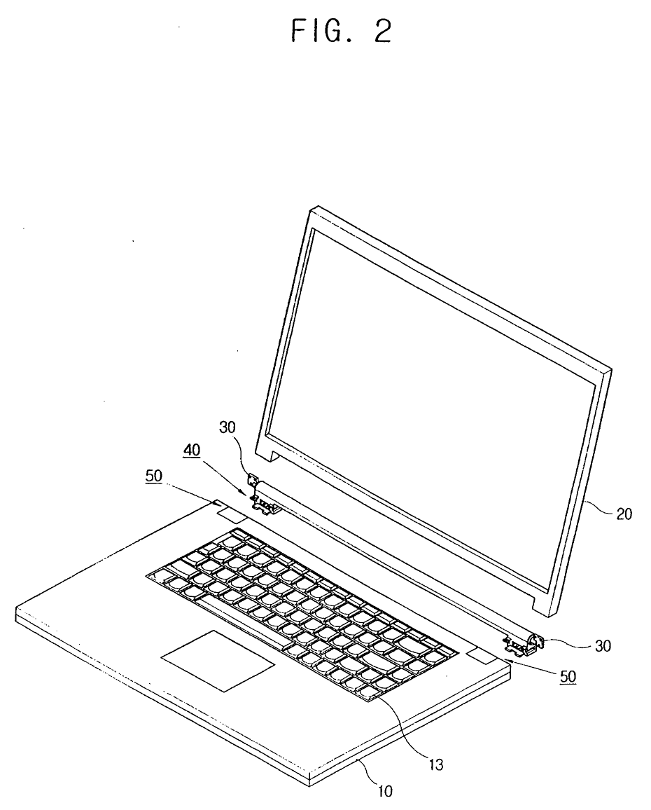

As illustrated in FIGS. 1 and 2, the computer main body 10 is seated on a horizontal surface such as a table. The computer main body 10 includes components internally mounted on a main board, a central processing unit (CPU) to control operations of the portable computer, components to generate a video signal and a keyboard 13 provided on the computer main body 10 to allow a user to input data.

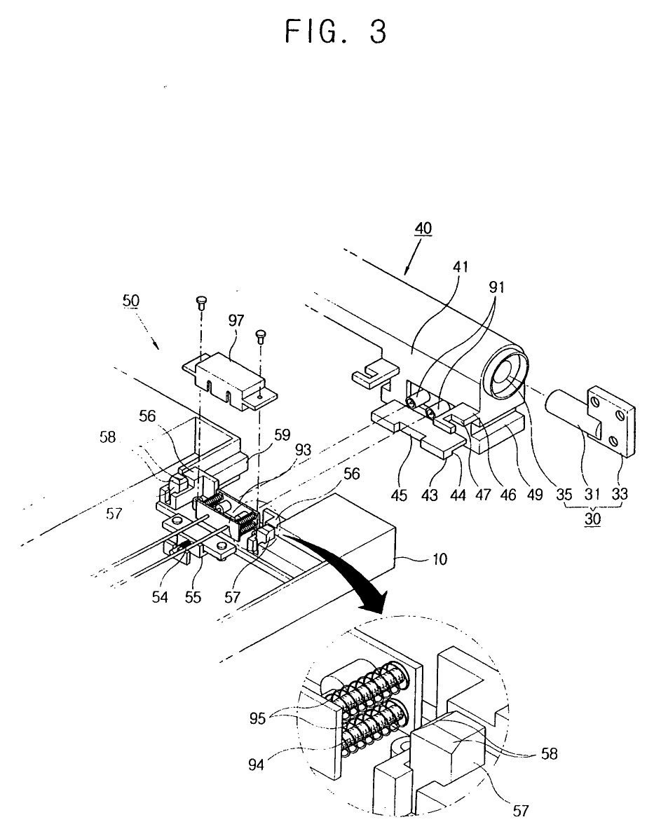

The display 20 receives the video signal and displays a picture based on the video signal. The display 20 includes a driving circuit (not shown) to display a picture based on the received video signal. The display 20 may include a thin and lightweight LCD panel to display the picture. The display 20 may include a flat panel display such as a plasma display panel (PDP). Referring to FIG. 3, the display 20 is coupled to a shaft supporter 33 of a hinge 30 and may be tilted to the coupling unit 40.

As illustrated in FIGS. 2 and 3, the hinge 30 supports the display 20 and the coupling unit 40 so that the display 20 may be tilted to the coupling unit 40 about a left-to-right axis. The hinge 30 may be included on each end of the display 20. Each hinge 30 includes a hinge shaft 31 provided between the display 20 and the coupling unit 40, the shaft supporter 33 provided in a first side of the hinge shaft 31 and coupled to the display 20, and a shaft accommodator 35 provided in the coupling unit 40 to accommodate a second side of the hinge shaft 31. Thus, the hinge 30 allows the display 20 to be not only folded on the computer main body 10 but also opened from the computer main body 10 at a predetermined angle, as shown in FIG. 1.

As illustrated in FIG. 3, the hinge shaft 31 forms the left-to-right axis, and forms a pair to connect lower opposite sides of the display 20 corresponding to ones of upper opposite sides of the coupling unit 40, respectively.

The shaft supporter 33 is formed extending from the first side of the hinge shaft 31 and coupled to the display 20 by a screw or the like, to rotate integrally with the display 20.

The shaft accommodator 35 is rotatably coupled with the second side of the hinge shaft 31, having predetermined friction between the shaft accommodator 35 and the second side of the hinge shaft 31. Thus, a user may tilt the display 20 to the computer main body 10 by pushing the display 20 with force stronger than the friction.

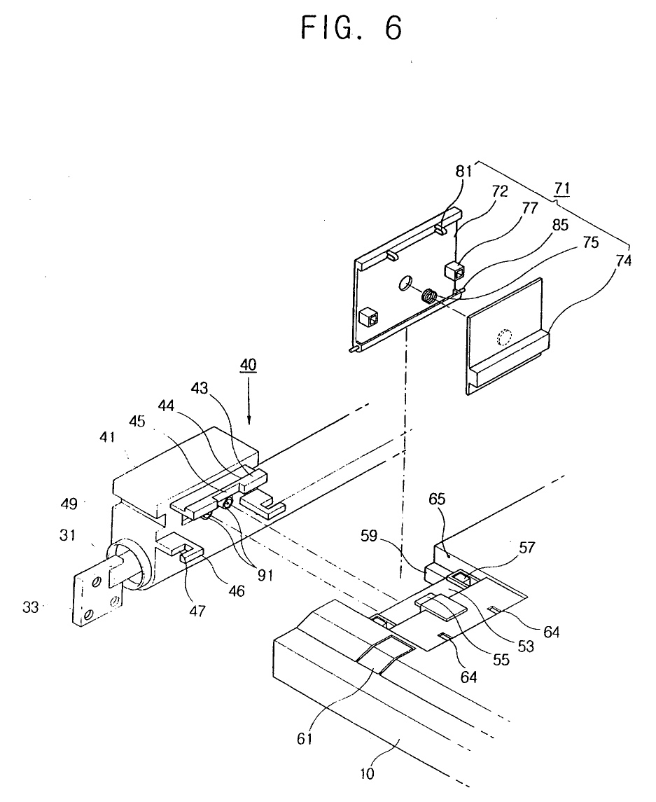

As illustrated in FIGS. 3 and 6, the coupling unit 40 is coupled to the coupling unit supporter 50 in a front-to-back direction of the computer main body 10. The front-to-back direction may be parallel to a major surface of the computer main body 10. In other embodiments it is possible that, the coupling unit 40 may be coupled to the coupling unit supporter 50 detachably in an up-and-down direction or in a left-to-right direction of the computer main body 10. The up-or-down direction forms an angle (i.e., a right angle) with the major surface of the computer main body 10, and the left-to-right direction may be parallel to the left to right axis of the computer main body 10. The coupling unit 40 includes a main body 41 and an insertion member (second locking member) 43 protruding from the main body 41 toward the coupling unit supporter 50. Further, the coupling unit 40 may include a locking member 46 (first locking member) protruding from the main body 41 to the coupling unit supporter 50. Additionally, the coupling unit 40 may include a slide part 49 to be guided by a guide part 59 of the coupling unit supporter 50, and a connector 91 to be connected with a connection port 93 of the coupling unit supporter 50.

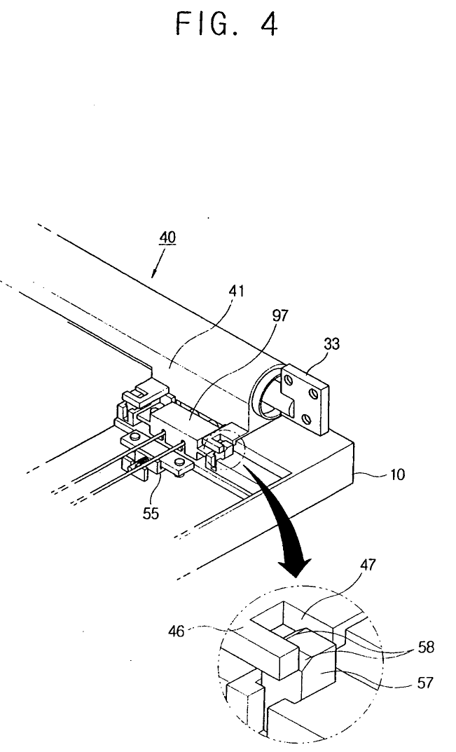

As illustrated in FIGS. 2 and 3, the main body 41 is elongated along an axial direction of the hinge shaft 31 so that the display 20 may be easily tilted about an axis of the hinge shaft 31, the axial direction may be along the left-to-right axis. The main body 41 is provided with the shaft accommodator 35 at opposite sides thereof to receive corresponding hinge shaft 31. The main body 41 is disposed in the back of the computer main body 10 when the coupling unit 40 is coupled to the coupling unit supporter 50. That is, the main body 41 is inserted in the coupling unit supporter 50 from the back to the front of the coupling unit supporter 50 when the coupling unit 40 is coupled to the coupling unit supporter 50. Because the main body 41 is disposed in the back of the computer main body 10 as illustrated in FIGS. 3 and 4, the portable computer 1 may have a thin thickness.

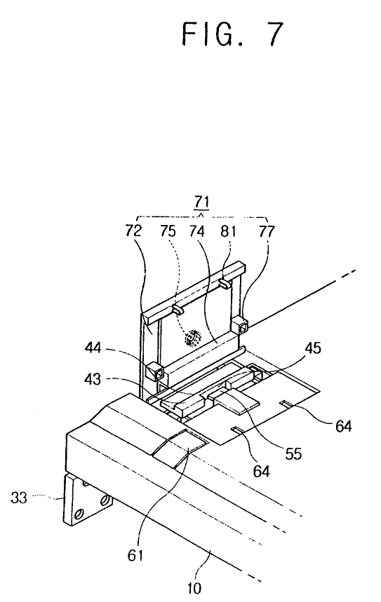

As illustrated in FIGS. 6 and 7, the insertion member 43 protrudes from the main body 41, having a section elongated in the left-to-right direction. According to the present embodiment, a pair of insertion members 43 is provided in the opposite sides of the main body 41. However, it is possible that one insertion member or three or more insertion member may be provided in the main body 41. The insertion member 43 includes a projection 44 formed in a transverse direction to an insertion direction of the insertion member 43. Further, the insertion member 43 may include a projection contact part 45 formed on the projection 44 in an opposite direction to the insertion direction of the insertion member 43.

The projection 44 is coupled to a holder 74 of a fastening member 71 so as to prevent the insertion member 43 from breaking away in a backward direction in a state that the insertion member 43 is accommodated in the coupling unit supporter 50. The fastening member 21 is rotatably coupled to a portion of the computer main body 10 which defines a space to accommodate components of the coupling unit supporter 50. According to the present embodiment, the projection 44 is formed on a lower surface of the insertion member 43 and elongated in the left-to-right direction.

The projection contact part 45 is contactable with an elastic projection 55 so as to prevent the insertion member 43 from moving in the front-to-back direction while the insertion member 43 is accommodated in the coupling unit supporter 50. Here, the projection contact part 45 may be grooved to accommodate the elastic projection 55. Thus, the coupling unit 40 is accommodated in and coupled to the coupling unit supporter 50 without moving in the front-to-back direction.

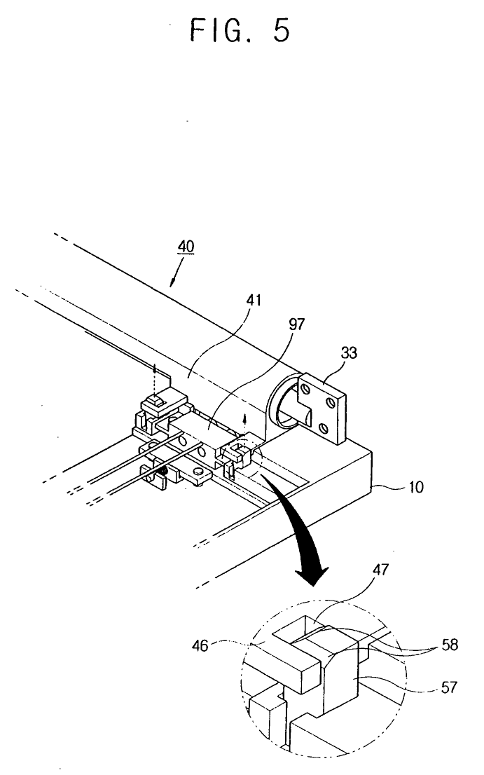

As illustrated in FIGS. 3 and 5, the locking member 46 protrudes from the main body 41, being spaced apart from the insertion member 43. According to the present embodiment, a pair of locking members 46 are provided on the opposite sides of the main body 41. That is, the pair of locking members 46 is provided to correspond to each insertion member 43. It is possible that, one locking member or three or more locking member may be provided corresponding to the insertion member of the main body 41. According to the present embodiment, the locking member 46 is provided above the insertion member 43 in parallel with the insertion member 43. Further, the locking member 46 includes a locking part 47 formed in the transverse direction to the insertion direction of the locking member 46.

The locking part 47 is coupled to a locking projection 57 so as to prevent the locking member 46 from breaking away in the backward direction while the locking member 46 is accommodated in the coupling unit supporter 50. The locking part 47 is formed by cutting away a part of the locking member 46 having a plate shape so that the locking projection 57 may move up and down to be locked to and released from the locking part 47. The pair of locking parts 47 is bilateral-symmetrically provided in the locking member 46.

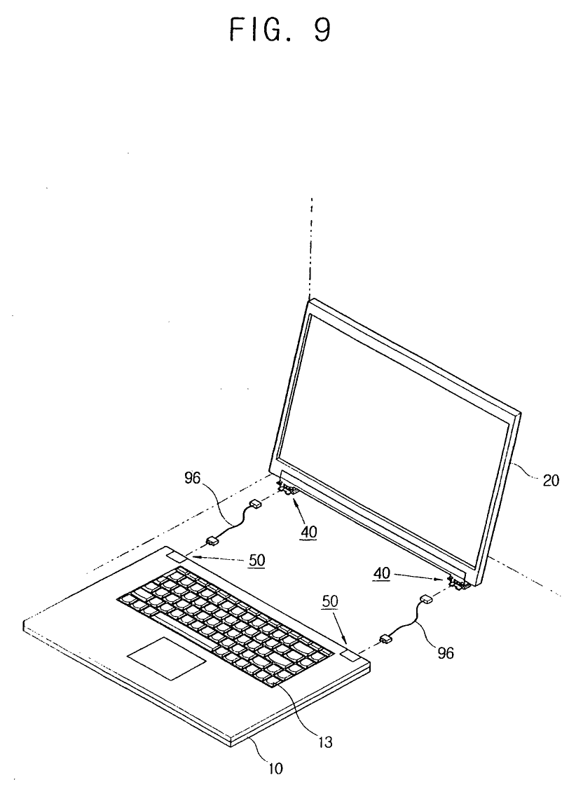

As illustrated in FIGS. 3 and 9, the slide part 49 is provided in the main body 41 accommodated in the coupling unit supporter 50. The slide part 49 is provided in the opposite side of the main body 41 and coupled to the guide part 59 of the coupling unit supporter 50. The slide part 49 is grooved along the front-to-back direction to accommodate the guide part 59. Thus, the slide part 49 is guided by the guide part 59 when the coupling unit 40 is coupled to the coupling unit supporter 50, so that the coupling unit 40 is easily coupled to the coupling unit supporter 50.

As illustrated in FIGS. 3 and 6, the connector 91 is provided for to supply power and the video signal from the computer main body 10 to the display 20. In the case where the display 20 includes an antenna (not shown), the connector 91 may transmit a signal from the antenna to the computer main body 10 or the like. The connector 91 is provided in the main body 41 and connected to the connection port 93. According to the present embodiment, a pair of connectors 91 are provided in the opposite sides of the main body 41. The coupling unit 40 may have one connector or three or more connectors to be provided in the main body.

As illustrated in FIGS. 3 through 8, the coupling unit supporter 50 is disposed in the back of the computer main body 10 and detachable from the coupling unit 40. The coupling unit supporter 50 may be disposed in an upper side or a lateral side of the computer main body 50. The coupling unit supporter 50 allows the coupling unit 40 to move in the front-to-back direction of the computer main body 10 and to be detached from the coupling unit supporter 50. In another embodiment, the coupling unit supporter 50 and the coupling unit 40 may be detachably coupled to each other in the up-and-down direction or in the left-to-right direction of the computer main body 10. The coupling unit supporter 50 includes an insertion member accommodator 53 to accommodate the insertion member 43 therein (refer to FIG. 6). The coupling unit supporter 50 further includes the fastening member 71 having the holder 74 coupled to the insertion member 43 so that the insertion member 43 is maintained as being accommodated in the insertion member accommodator 53 (refer to FIGS. 6 and 7). Further, the coupling unit supporter 50 includes the elastic projection 55 elastically pushing the insertion member 43 in the opposite direction to the insertion direction thereof (refer to FIGS. 6 and 7). Further, the coupling unit supporter 50 includes a locking member accommodator 56 (refer to FIG. 3) to accommodate the locking member 46, and the locking projection 57 movable in the transverse direction to the insertion direction of the locking member 46 (refer to FIGS. 3 and 7). Further, the coupling unit supporter 50 may be provided with the guide part 59 formed along the front-to-back direction, and the connection port 93 connected to the connector 91 (refer to FIGS. 3 and 6). According to of the present embodiment, a pair of coupling unit supporters 50 is provided corresponding to the main body 41 of the coupling unit 40 in the back opposite sides of the computer main body 10 (refer to FIG. 2). In another embodiment, one coupling unit supporter or three or more coupling unit supporters may be provided in the computer main body 10.

As illustrated in FIG. 6, the insertion member accommodator 53 is opened in the back of the coupling unit supporter 50 to accommodate the insertion member 43. Here, a pair of insertion member accommodators 53 is provided in the opposite sides of the computer main body 10 in correspondence to the pair of insertion members 43.

As illustrated in FIGS. 6 and 7, the elastic projection 55 is provided inside the insertion member accommodator 53 and elastically pushes the insertion member 43 in the opposite direction to the insertion member. Here, the elastic projection 55 employs an elastic spring 54 to elastically push the insertion member 43. In another embodiment, the elastic projection 55 may be made of a resilient material such as rubber. The elastic projection 55 is in contact with the projection contact part 45 when the insertion member 43 is accommodated in the insertion member accommodator 53, thereby elastically pushing and preventing the insertion member 43 from swaying in the front-to-back direction within a spaced distance. Thus, the coupling unit 40 is coupled without swaying in the front-to-back direction within the spaced distance. However, the coupling unit 40 may elastically move in the front-to-back direction by the elastic projection 55.

As illustrated in FIG. 3, the locking member accommodator 56 is opened in the back of the coupling unit supporter 50 to accommodate the locking member 46. Here, a pair of locking member accommodators 56 are provided in the opposite sides of the computer main body 10 in correspondence to two pairs of locking members 46.

As illustrated in FIGS. 4 and 7, the locking projection 57 is provided movably in the up-and-down direction of the computer main body 10 so that the locking projection 57 is coupled to the locking part 47 of the locking member 46. The locking projection 57 is inserted in the locking part 47 and prevents the locking member 46 from moving away in the backward direction. The locking projection 57 may move in the up-and-down direction as the fastening member 71 rotates to cover the space of the coupling unit supporter 50 to be coupled to the coupling unit 40 (refer to FIGS. 5 and 7). A space tolerance between the locking projection 57 and the locking part 47 is small enough to prevent the locking member 46 from swaying in the left-to-right direction and the front-to-back direction when the locking projection 57 is completely inserted in the locking part 47. In this case, the locking projection 57 contacting the locking part 47 is formed with an inclined part 58 narrowing toward the end thereof (refer to FIG. 3), so that the locking projection 57 may be easily inserted in the locking part 47. Thus, the locking projection 57 may be easily inserted in the locking part 47 by the inclined part 58 while the locking projection 57 is inserted in the locking part 47, and the locking projection 57 almost prevents the locking member 46 from swaying in the front-to-back and left-to right directions after the locking projection 57 is completely inserted in the locking part 47.

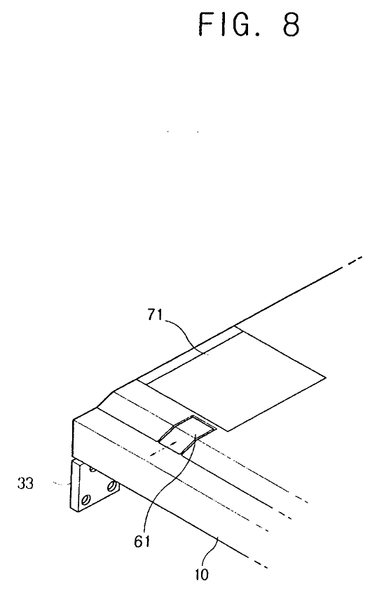

As shown in FIGS. 6 and 8, the fastening member 71 includes the holder 74 to hold the projection 44 so as to prevent the insertion member 43 from breaking away in the backward direction. Further, the fastening member 71 includes a spring member 75 pressing the holder 74 against the projection 44. Also, the fastening member 71 includes a locking projection pusher 77 to push the locking projection 57 to couple the locking projection 57 with the locking part 47. That is, the locking projection pusher 77 controls the locking projection 57 to move up or down to be coupled to or uncoupled from the locking part 47. The fastening member 71 is provided in the bottom of the computer main body 10 and holds the projection 44. Further, the fastening member 71 includes a hinge pin 85 provided in a first side of the fastening member 71 and to allow the fastening member 71 to rotate on the computer main body 10, a hook 81 provided in a second side of the fastening member 71 and to couple the fastening member 71 with the coupling unit supporter 50 as the fastening member 71 rotates about the hinge pin 85, and a fastening main body 72 to support the hinge pin 85 and the hook 81.

As illustrated in FIGS. 6 and 7, the hinge pin 85 is provided in the first side of the fastening main body 72, and the hook 81 is provided in the second side of the fastening main body 72. The fastening main body 72 is shaped like a plate and provided in the back bottom of the computer main body 10. The fastening main body 72 may rotate about the hinge pin 85 at a predetermined angle, so that the fastening main body 72 contacts an installation surface such as a table and supports a back region of the computer main body 10 to be lifted up at a predetermined height. Thus, the coupling unit 40 may be easily coupled to the coupling unit supporter 50 while the back region of the computer main body 10 is supported and lifted up by the fastening main body 72.

As illustrated in FIGS. 6 and 7, the holder 74 holds the projection 44 to prevent the insertion member 43 coupled to the fastening main body 72 and coupled to the insertion member accommodator 53 from breaking away in a backward direction of the insertion direction. Here, the holder 74 protrudes toward the projection 44 so as to be inserted in a groove defining the projection 44.

The locking projection pusher 77 is provided in the fastening main body 72 and pushes the locking projection 57 as the fastening member 71 rotates (refer to FIG. 7). Thus, the locking projection 57 is pushed by the locking projection pusher 77, thereby moving up and being inserted in the locking part 47 (refer to FIG. 5).

As illustrated in FIG. 6, the spring member 75 is provided between the holder 74 and the fastening main body 72 and presses the holder 74 toward the projection 44. Further, the insertion member 43 is pressed up by the spring member 75, so that the insertion member 43 is prevented from swaying in the up-and-down direction. Thus, the coupling unit 40 is coupled to the coupling unit supporter 50 without swaying in the up-and-down direction. However, the coupling unit 40 may elastically move in the up-and-down direction by the spring member 75.

As illustrated in FIG. 6, the hinge pin 85 protrudes from the first opposite sides of the fastening main body 72, and is rotatably coupled to the hinge pin accommodator 65 provided in the coupling unit supporter 50.

As illustrated in FIGS. 6 and 7, the hook 81 protrudes from the second side of the fastening main body 72. Correspondingly, the coupling unit supporter 50 is provided with a lever 61 to be locked to and released from the hook 81.

As illustrated in FIGS. 6 through 8, the lever 61 has a first side exposed to the outside of the computer main body 10 to allow a user to easily manipulate it, and a second side having a hook projection (not shown). The hook projection is accommodated inside the computer main body 10 and corresponds to a hook accommodator 64 formed in the coupling unit supporter 50 and accommodating the hook 81, thereby being locked to and released from the hook 81. Thus, the fastening member 71 rotates about the hinge pin 85, and is locked to and released from the coupling unit supporter 50 by the lever 61.

As illustrated in FIGS. 3 and 6, the guide part 59 is provided in the coupling unit supporter 50 in correspondence to the slide part 49. The guide part 59 protrudes from the opposite sides of the coupling unit supporter 50 and is inserted in the slide part 49, thereby guiding the slide part 49. Thus, the coupling unit 40 may be easily attached to and detached from the coupling unit supporter 50 by the guide part 59 and the slide part 49.

As illustrated in FIGS. 3 and 4, the connection port 93 is coupled to the coupling unit supporter 50 so that the connector 91 is connected to the connection port 93. Further, a port elastic member 95 is provided between the connection port 93 and the coupling unit supporter 50 and allows the connection port 93 to be elastically coupled to the coupling unit supporter 50. Here, the connection port 93 is fastened to the coupling unit supporter 50 by a screw 94. Further, the connection port 93 and the port elastic member 95 may be covered with a connection port cover 97.

As illustrated in FIG. 3, the port elastic member 95 may be achieved by a coil spring in which the screw 94 is inserted. Thus, the port elastic member 95 not only absorbs a shock of when the connector 91 is connected to the connection port 93, but also prevents damage by allowing the connection port 93 to elastically move when the coupling unit 40 sways with respect to the coupling unit supporter 50. Further, as illustrated in FIG. 9, a connection cable 96 is provided for connecting the connector 91 with the connection port 93 when the display 20 is detached from the computer main body 10.

As illustrated in FIG. 9, the connection cable 96 has a first end connected to the connector 91 provided in the coupling unit 40, and a second end connected to the connection port 93 provided in the coupling unit supporter 50. Thus, the display 20 and the computer main body 10 are connected by the connection cable 96 in the state that the display 20 is detached from the computer main body 10, so that the display 20 may be separated from the computer main body 10 and installed at various places such as a wall, thereby being used as a monitor (refer to FIG. 9). In another embodiment, the connection cable 96 may have the first end connected to the connector 91, and the second end connected to a connection port provided in a separate computer system (not shown). Thus, the detached display 20 may be connected to not the computer main body 10 but another computer system (not shown) and used as a separate monitor.

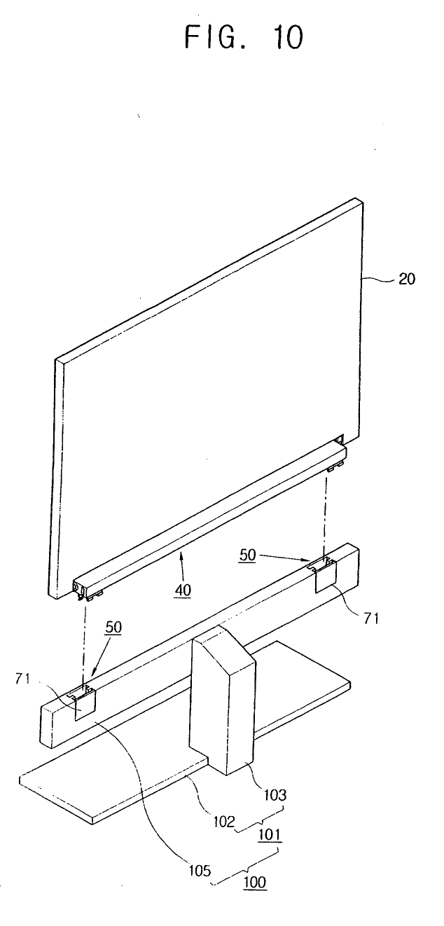

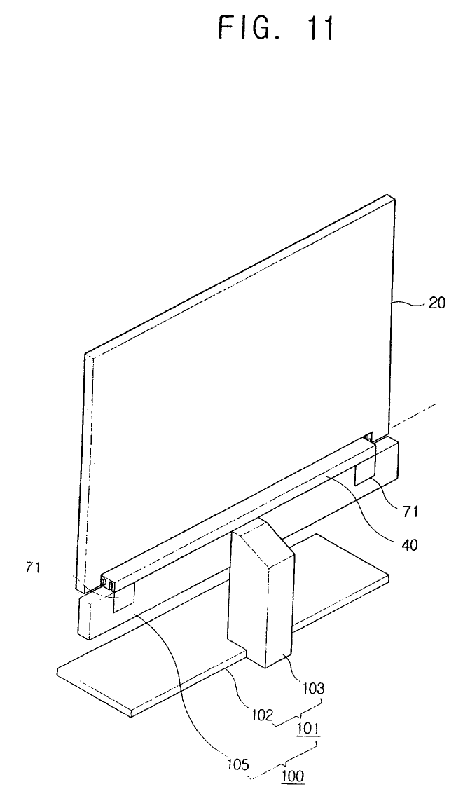

FIGS. 10 and 11 are perspective views illustrating that the display detached from the portable computer according to the present embodiment is coupled to a display supporting apparatus 100.

A display supporting apparatus 100 includes a stand 101, and a supporter 105 provided in the stand 101 and including the coupling unit supporter 50 to be detachably coupled with the coupling unit 40 coupled to the display 20.

The stand 101 includes a base unit 102 seated on a predetermined horizontal surface, and a stand unit 103 to stand on the base unit 102. The stand 101 may include a socket (not shown) to which the computer main body 10 or other computer system (not shown) is connected to communicate power, a video signal, etc. with the display 20.

The supporter 105 is coupled with the stand unit 103 to support the display 20. The supporter 105 includes the foregoing coupling unit supporter 50 to which the coupling unit 40 is detachably coupled.

The coupling unit supporter 50 provided in the supporter 105 is detachably coupled with the coupling unit 40 in an up-and-down direction of the supporter 105. That is, the coupling unit 40 is coupled to the coupling unit supporter 50 of the computer main body 10 in the direction from the back to the front of the computer main body 10. However, the coupling unit 40 is coupled to the coupling unit support 50 of the supporter 105 in a direction from the top to the bottom of the supporter 105 (refer to FIGS. 10 and 11). Alternatively, the coupling unit 40 may be coupled to the coupling unit supporter 50 provided in the supporter 105 in a direction from the back to the front of the supporter 105.

The display 20 coupled to the supporter 105 may be tilted to the supporter 105. That is, the display 20 may be tilted about the hinge shaft 31 of the hinge 30. Thus, a user may adjust a tilting angle of the display 20 after coupling the display 20 to the supporter 105.

With this configuration, the portable computer 1 according to an the present embodiment operates as follows.

First, a process to couple a detached coupling unit 40 to the coupling unit supporter 50 will be described with reference to FIGS. 3 and 6. The insertion member 43 and the locking member 46 provided in the main body 41 of the coupling unit 40 are inserted in the insertion member accommodator 53 and the locking member accommodator 56, respectively (refer to FIGS. 4 and 7). At this time, the slide part 49 of the main body 41 is guided by the guide part 59, thereby allowing the insertion member 43 and the locking member 46 to be easily inserted in the insertion member accommodator 53 and the locking member accommodator 56, respectively. Further, the fastening member 71 is rotated so that the hook 81 is locked to the lever 61 (refer to FIGS. 7 and 8). Then, the holder 74 holds the projection 44 of the insertion member 43, and the locking projection 57 is coupled to the locking part 47 (refer to FIGS. 5 and 7). Further, the connector 91 provided in the main body 41 is connected to the connection port 93 (refer to FIGS. 4 and 5). Thus, the coupling unit 40 is coupled to the coupling unit supporter 50. Therefore, a user may easily attach the display 20 to the computer main body 10 by rotating the fastening member 71 until the hook 81 is locked to the lever 61 after inserting the coupling unit 40 in the coupling unit supporter 50.

On the other hand, the coupling unit 40 is separated from the coupling unit supporter 50 as follows. First, the lever 61 is pulled or pushed to release the hook projection from the hook 81 (refer to FIG. 8). At this time, the fastening member 71 rotates about the hinge pin 85 by the elasticity of the spring member 75. At the same time the holder 74 and the locking projection 57 are released from the projection 44 and the locking part 47, respectively (refer to FIGS. 5 and 7). Then, the insertion member 43 and the locking member 46 are separated from the insertion member accommodator 53 and the locking member accommodator 56, respectively (refer to FIGS. 3 and 6). Thus, a user may easily detach the display 20 from the computer main body 10 by manipulating the lever 61 and separating the coupling unit 40 from the coupling unit supporter 50.

According to the present embodiment, a display 20 is attached to a coupling unit supporter 50 of a computer main body 10 by employing a plurality of coupling means such as an insertion member 43 and a locking member 46 provided in a coupling unit 40, so that attachment between the display 20 and the computer main body 10 is enhanced.

Further, the coupling unit 40 and the coupling unit supporter 50 are coupled by employing an elastic projection 55 provided in the coupling unit supporter 50, a spring member 75 provided in a fastening member 71, so that there is little spaced distance between the coupling unit 40 and the coupling unit supporter 50. Therefore, the display 20 is prevented from swaying due to the spaced distance with respect to the computer main body 10.

Also, a connection port 93 is provided with a port elastic member 95, so that the connection port 93 and the connector 91 are prevented from damage or the like.

As illustrated in FIG. 9, the display 20 detached from the computer main body 10 may be disposed in various places such as a wall and connected to the computer main body 10 or the like by the connection cable 96, so that it may be used as a separate monitor.

As illustrated in FIGS. 10 and 11, the display 20 separated from the computer main body 10 may be coupled to a separate display supporting apparatus 100 and used as a monitor. Further, the hinge 30 is provided between the display 20 and the coupling unit 40, so that the display 20 may be tilted about the hinge 30 while being coupled to the display supporting apparatus 100.

Also, in the case that the display 20 gets out of order or the like case, a user may easily detach the display 20 from the computer main body 10 and replace the attached display 20 with another display, or a new one.

As described above, the present general inventive concept provides a portable computer in which a display may be easily detached from and coupled to a computer main body, and the detached display may have a tilting function.

Further, the present general inventive concept provides a portable computer in which a display may be detached from a computer main body and used as a monitor.

Also, the present general inventive concept provides a portable computer in which a display is almost prevented from swaying due to a spaced distance with respect to a computer main body.

Although a few embodiments of the present general inventive concept have been shown and described, it will be appreciated by those skilled in the art that changes may be made in these embodiments without departing from the principles and spirit of the invention, the scope of which is defined in the appended claims and their equivalents.

What is claimed is:

1. A portable computer comprising:
a computer main body;
a display;
a coupling unit rotatably coupled with the display; and
a coupling unit supporter provided in the computer main body to be coupled with and released from the coupling unit.

2. The portable computer according to claim 1, wherein:
the coupling unit supporter is provided in a back region of the computer main body; and
the coupling unit is detachably coupled to the coupling unit supporter in a front-to-back direction of the computer main body.

3. The portable computer according to claim 2, wherein:
the coupling unit comprises a main body, and an insertion member protruding from the main body toward the coupling unit supporter; and
the coupling unit supporter comprises an insertion member accommodator to accommodate the insertion member.

4. The portable computer according to claim 3, wherein the coupling unit supporter further comprises a fastening member coupled with the insertion member to keep the insertion member accommodated in the insertion member accommodator.

5. The portable computer according to claim 4, wherein the coupling unit supporter further comprises an elastic projection to press the insertion member in an opposite direction to an insertion direction of the insertion member.

6. The portable computer according to claim 4, wherein:
the insertion member further comprises a projection formed in a transverse direction to an insertion direction of the insertion member; and
the fastening member comprises a holder to hold the projection to prevent the insertion member from breaking away in a backward direction.

7. The portable computer according to claim 6, wherein the fastening member further comprises a spring member to press the holder toward the projection.

8. The portable computer according to claim 6, wherein:
the fastening member comprises a hinge pin provided in a first side of the fastening member to allow the fastening member to pivot on a first region of the coupling unit supporter, and a hook in a second side the fastening member locked to a second region of the coupling unit supporter as the fastening member pivots on the hinge pin; and
the coupling unit supporter comprises a lever to lock and release the hook.

9. The portable computer according to claim 3, wherein:
the coupling unit further comprises a locking member protruding from the main body toward the coupling unit supporter; and
the coupling unit supporter further comprises a locking member accommodator to accommodate the locking member.

10. The portable computer according to claim 9, wherein:
the coupling unit supporter further comprises a locking projection that is movable in a transverse direction to an insertion direction of the locking member; and
the locking member further comprises a locking part coupled with the locking projection when the locking member is accommodated in the locking member accommodator.

11. The portable computer according to claim 10, wherein:
the locking projection is movable in an up-and-down direction with respect to the computer main body; and
the locking part accommodates the locking projection.

12. The portable computer according to claim 11, wherein the locking projection contacting the locking part comprises an inclined part narrowing toward the end thereof.

13. The portable computer according to claim 9, wherein
the coupling unit supporter further comprises a fastening member to be coupled with the insertion member and to keep the insertion member to be accommodated in the insertion member accommodator; and
the locking projection is inserted in the locking part by the fastening member.

14. The portable computer according to claim 3, wherein
the coupling unit supporter comprises a guide part formed in a front-to-back direction; and
the coupling unit comprises a slide part to be guided by the guide part.

15. The portable computer according to claim 3, wherein:
the coupling unit comprises a connector; and
the coupling unit supporter comprises a connection port connected with the connector.

16. The portable computer according to claim 15, further comprising:
a port elastic member provided between the connection port and the coupling unit supporter to allow the connection port to be elastically movable and coupled to the coupling unit supporter.

17. The portable computer according to claim 15, further comprising:
a connection cable to connect the connector with the connection port when the display is detached from the computer main body.

18. The portable computer according to claim 1, further comprising:
a display supporting apparatus to support the display when the display is detached from the computer main body.

19. The portable computer according to claim 18, wherein the display supporting apparatus comprises:
a stand; and
a supporter provided in the stand and comprising a second coupling unit to be attached and detached from the coupling unit.

20. The portable computer according to claim 19, wherein the second coupling unit supporter is attached to and detached from the coupling unit in an up-and-down direction of the supporter.

21. A portable computer comprising:
a computer main body;
a display;
a coupling unit having a hinge unit coupled to the display,
a main body rotatably connected to the hinge unit, and
a first and a second locking member;
a coupling unit supporter to be coupled to the first locking member of the coupling unit; and
a fastening member to couple the second locking member of the coupling unit to the coupling unit supporter.

22. The portable computer of claim 21, wherein:
the coupling unit further comprising a connector; and
the coupling unit supporter comprising a connection cable to be connected to the computer to supply a video and a power to the display.

23. A portable computer comprising:
a computer main body having a key unit and a component to generate a video signal;
a display to display the video signal;
a coupling unit mounted on the display;
a coupling unit supporter mounted on the computer main body to be detachably connected to the coupling unit; and
a supporting apparatus having a supporter having a second coupling unit supporter mounted thereon to be detachably coupled to the coupling unit.
